(19) United States
(12) Patent Application Publication
(10) Pub. No.: US 2007/0202305 A1
(43) Pub. Date: Aug. 30, 2007

(54) Floor including wood powder and method of manufacturing the same

(75) Inventor: Hyun-Dae Sun, Hwaseong-si (KR)

Correspondence Address: STEIN, MCEWEN & BUI, LLP, 1400 EYE STREET, NW, SUITE 300, WASHINGTON, DC, 20005, US

(73) Assignee: DOOIL CO., LTD., Hwaseong-si (KR)

(21) Appl. No.: 11/655,908

(22) Filed: Jan. 22, 2007

(30) Foreign Application Priority Data
Feb. 24, 2006 (KR) 10-2006-18041
Apr. 24, 2006 (KR) 10-2006-36546
Dec. 6, 2006 (KR) 10-2006-122715

(51) Int. Cl. B41M 5/00

(52) U.S. Cl. 428/195.1

(57) ABSTRACT

Disclosed is a method of manufacturing floors including wood powder in order to exhibit a texture similar to that of natural wood. The floor including wood powder of the invention is composed of a main sheet formed of synthetic resin, a wood powder layer formed on the main sheet using a mixture of wood powder and synthetic resin, and a printing layer formed on the wood powder layer and having a non-toxic portion. The printing layer is attached when heated due to changes in the melting point of the main sheet, and the non-toxic portion of the printing layer is formed of any one material selected from among polypropylene, polyethylene, ethylene-vinyl acetate copolymer, and oriented polypropylene.

### CROSS-REFERENCE TO RELATED APPLICATIONS

This application claims the benefit of Korean Application No. 2006-18041, filed Feb. 24, 2006, Korean Application No. 2006-36546, filed Apr. 24, 2006, and Korean Patent Application No. 2006-122715, filed Dec. 6, 2006, in the Korean Intellectual Property Office, the disclosures of which are incorporated herein by reference.

### BACKGROUND OF THE INVENTION

1. Field of the Invention

The present invention relates to a method of manufacturing a floor including wood powder in order to exhibit a texture similar to that of natural wood.

2. Description of the Related Art

Generally, for floors for use in homes or offices, such as tiles or oilpaper-floors, various attempts have been made to impart the upper surface of a synthetic resin sheet with various colors, to apply a protective coating layer for preventing breakage and discoloration of the surface of the floor so as to improve the durability thereof, and also, to improve the quality of printing so as to realize a feel similar to that of carpet or natural material, such as a wood or marble pattern. Further, with the aim of mitigating the environmental problem of the emission of hormones from petrochemical products, products incorporating a non-toxic component, such as far infrared radiation emitting material, a deodorization component, or silver, are increasingly being developed. Furthermore, a lot of effort has been directed toward the formation of irregular surfaces having various patterns to thus realize a feel similar to wood, stone, or fiber in terms of color and texture.

In particular, as conventional techniques for representing a wood texture, Japanese Unexamined Patent Publication No. 1996-169092 (laid open on Jul. 2, 1996) discloses an extruded product using resin containing wood powder and a production method thereof, and also Korean Unexamined Patent Publication No. 1999-018964 (laid open on Mar. 15, 1999) discloses a decorative floor having a wood powder printing layer and a manufacturing method thereof.

The above conventional techniques also pertain to floors using wood powder. Specifically, Japanese Unexamined Patent Publication No. 1996-169092 discloses a molded product produced by extruding a base sheet formed of vinyl chloride and a surface layer of a vinyl chloride resin composition comprising wood powder, a stabilizer, and a lubricant. In addition, Korean Unexamined Patent Publication No. 1999-018964 discloses a decorative floor, comprising a wood powder printing layer composed of vinyl chloride resin, wood powder, a plasticizer, and a stabilizer, on which a transparent layer and a UV coating layer are sequentially formed.

That is, the above conventional techniques have been devised to realize a texture similar to that of wood, as in the present invention.

Although the conventional techniques use wood powder, they are of limited usefulness in realizing the best wood texture due to differences in the preparation process or materials. Moreover, it is difficult to manufacture floors which are environmentally friendly while minimizing the use of harmful materials. In particular, synthetic resin, used in the conventional techniques, is mainly polyvinyl chloride (PVC), which is undesirably poisonous and thus harmful to human bodies.

### SUMMARY OF THE INVENTION

The present invention has been proposed to realize wood texture floors using a natural component, in particular, wood powder, and thus is considered to improve the quality of floors in the related art.

Accordingly, an object of the present invention is to provide a floor including wood powder and a method of manufacturing the same, comprising a wood powder layer formation step of laminating or pressing a wood powder layer, in particular, a separately molded wood powder sheet, on a main sheet made of synthetic resin using a wood powder paste containing wood powder, and a patterning step of forming a printing layer having a non-toxic portion on the wood powder layer.

Another object of the present invention is to provide a floor including wood powder and a method of manufacturing the same, in which the printing layer is formed using synthetic resin, selected from among polypropylene (PP), polyethylene (PE), ethylene-vinyl acetate copolymer (EVA), and oriented polypropylene (OPP), so as to eliminate harmful material and supply stabilized products to end consumers.

A further object of the present invention is to provide a floor including wood powder and a method of manufacturing the same, comprising a wood powder layer formation step of laminating a wood powder layer, in particular, a separately molded wood powder sheet, on a main sheet made of synthetic resin using a wood powder paste containing wood powder, and a patterning step of conducting a transfer process, a gravure printing process or a direct printing process on the wood powder layer.

Still another object of the present invention is to provide a method of manufacturing a floor, further comprising an aging step of passing the manufactured floor through a water bath containing water at 100˜180° C. so as to prevent deformation thereof due to contraction and expansion, depending on changes in temperature and humidity.

Yet another object of the present invention is to provide a method of manufacturing a floor, further comprising an embossing step for realizing a wood texture and a coating layer formation step for forming an antibacterial and scuff-resistant coating.

### BRIEF DESCRIPTION OF THE DRAWING

FIG. 1 is a block diagram illustrating the process of manufacturing the floor including wood powder, according to the present invention.

### DESCRIPTION OF THE PREFERRED EMBODIMENTS

According to the present invention, the floor including wood powder comprises a main sheet formed of synthetic resin, a wood powder layer formed on the main sheet, and a printing layer formed on the wood powder layer, in which the printing layer is composed of a non-toxic portion formed of any one material selected from among polypropylene (PP), polyethylene (PE), ethylene-vinyl acetate copolymer (EVA), and oriented polypropylene (OPP).

Further, the method of manufacturing the floor including wood powder comprises (a) a main sheet softening step of heating and softening a synthetic resin sheet, continuously transferred from a feed roller, using a heating means, (b) a wood powder layer formation step of forming a wood powder layer having a predetermined thickness on the softened main sheet using a wood powder paste comprising 30˜80 wt % of wood powder and 20˜70 wt % of synthetic resin containing an adhesive, and (c) a patterning step of applying a printing layer having a predetermined pattern on the laminate sheet.

In the present invention, the term “floor” refers to products including tiles, oilpaper-floors, or other floor mats (e.g., buffer mats for infants).

In the floor including wood powder of the present invention, the synthetic resin used in the main sheet is selected from the group consisting of polyvinyl chloride (PVC), polyethylene terephthalate (PET), polypropylene (PP), sulfonated polystyrene (SPS), polyethylene (PE), ethylene-vinyl acetate copolymer (EVA), oriented polypropylene (OPP), and mixtures thereof.

Upon the formation of the printing layer of the floor including wood powder of the present invention, in the case where a transfer printing process is employed, the base film of transfer paper used therein has an additional adhesive layer thereon, and thus the adhesive layer, an ink layer, and a release layer are sequentially formed on the base film.

The base film of the transfer paper used in the transfer printing process is formed of one selected from among polypropylene (PP), polyethylene (PE), ethylene-vinyl acetate copolymer (EVA), and oriented polypropylene (OPP).

Further, in the synthetic resin used in the floor including wood powder of the present invention, the synthetic resin for the wood powder layer should preferably be the same as the synthetic resin for the main sheet, so as to realize complete lamination.

In the method of manufacturing the floor including wood powder of the present invention, the wood powder itself is molded into a sheet, so that the wood powder and the main sheet are easily laminated, thus increasing productivity. To this end, in the wood powder layer formation step (b), 30˜80 wt % of the wood powder, and 20˜70 wt % of the synthetic resin comprising 15˜50 wt % of an adhesive and 5˜20 wt % of an adjuvant component containing a dispersant, based on the total amount of the wood powder paste, are fed into a mixer via a hopper, heated, mixed, and melted, giving a wood powder paste, which is then passed through a calender composed of a heating roller group and a cooling roller group to thus be molded into a wood powder sheet having a predetermined thickness, which is then laminated on the main sheet obtained in step (a). In consideration of a decrease in the weight of the floor and an increase in stability of the product, the adjuvant component can include a foaming agent, a stabilizer, a lubricant, and a softening agent, in addition to the dispersant.

In particular, for the process of forming the wood powder sheet on the main sheet, a laminating process and a pressing process may be considered.

Further, with the goal of preventing deformation of the floor due to contraction and expansion depending on changes in temperature and humidity to thus increase dimensional stability, the method of manufacturing the floor including wood powder according to the present invention further comprises (d) an aging step of passing the sheet through a water bath containing water at 100˜180° C., after the patterning step (c). Also, the method further comprises (b-1) a deformation prevention step of cooling the laminate sheet comprising the main sheet and the wood powder sheet to 20˜35° C., after the wood powder layer formation step (b). In addition, (e) a post treatment step including cooling, drying and cutting is further included.

In the method of manufacturing the floor including wood powder according to the present invention, the patterning step (c) may be performed using a transfer printing process, a gravure printing process, a direct printing process, or combinations thereof.

In the transfer printing process, the base film of the transfer paper is formed of any one selected from among polyethylene terephthalate (PET), polypropylene (PP), polyethylene (PE), ethylene-vinyl acetate copolymer (EVA), and oriented polypropylene (OPP). As such, the transfer process should be carried out at a temperature not lower than the softening temperature of the main sheet within a range that does not deform or damage the main sheet. To this end, a process of heating the main sheet is additionally performed.

The upper limit of the temperature for the transfer process, corresponding to the temperature limit within which the main sheet is not deformed or damaged, is determined depending on the type of material for the main sheet.

In the patterning step (c), the printing process is not necessarily limited to the transfer printing process, and may be performed through direct printing for patterning. When employing such a direct printing process, the printing paper used therein is formed of any one selected from among polyethylene terephthalate (PET), polypropylene (PP), polyethylene (PE), ethylene-vinyl acetate copolymer (EVA), and oriented polypropylene (OPP), in order to realize products which are nonpoisonous and environmentally friendly.

In the patterning step (c), the printing layer is formed on the laminate sheet comprising the wood powder layer and the main sheet using a transfer printing process or a direct printing process. In such a case, when the material for the printing layer is different from the material for the laminate sheet, they may be attached to each other using an additional AC adhesive. Alternatively, using a roller heated to a temperature not lower than the softening temperature of the main sheet within a range that does not deform or damage the main sheet, as explained above, the printing layer may be attached to the laminate sheet.

In the present invention, the wood powder layer formed using the mixture comprising synthetic resin and wood powder is laminated on the main sheet. As such, when the wood powder is mixed with the synthetic resin, the melting point of the laminate sheet comprising the wood powder layer and the main sheet is increased. In this way, thanks to this increase in melting point, when the printing layer having a material different from that of the laminate sheet is attached, the laminate sheet can also withstand the melting point of the printing layer. Therefore, even though the laminate sheet and the printing layer, having materials different from each other, are attached to each other, it is possible to obtain floors having good quality and a good finish and to avoid a phenomenon of separation therebetween.

In the method of manufacturing the floor including wood powder of the present invention, an embossing step is further performed before or after the patterning step (c), so that the texture of the floor feels like natural material, such as wood or rock. After the patterning step (c), a functional coating layer formation step is further conducted to realize antibiosis, UV blocking, scuff resistance, or all of them, resulting in highly reliable products.

Below, the method of manufacturing the floor including wood powder of the present invention is described in detail, in conjunction with the appended drawing.

The floor including wood powder of the present invention comprises the main sheet formed of synthetic resin, the wood powder layer integrated with the main sheet through laminating or pressing, and the printing layer for visually representing a designed pattern. These individual layers are formed as follows.

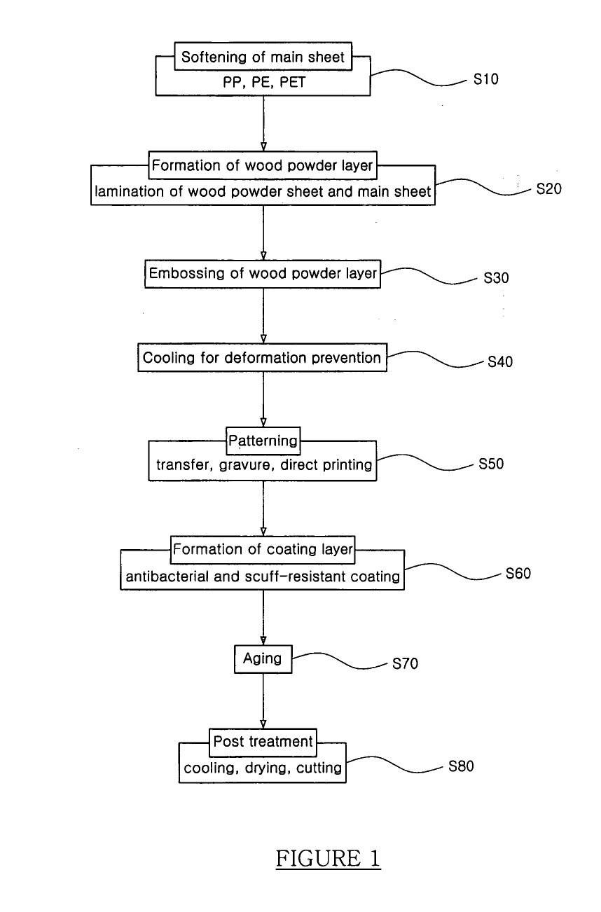

With reference to FIG. 1, in a softening step S10, in the case where a synthetic resin sheet, which is molded through laminating, is wound on a feed roller, the main sheet, continuously transferred from the feed roller, is heated and softened to be suitable for applying a wood powder paste to a predetermined thickness thereon in a subsequent wood powder layer formation step S20. The softening process may be performed using a heated transfer roller or a separately provided heater.

The material for the main sheet is selected from a group of general-use plastics having high price competitiveness, such as polyvinyl chloride (PVC), polyethylene (PE), polyethylene terephthalate (PET), polypropylene (PP), sulfonated polystyrene (SPS), ethylene-vinyl acetate copolymer (EVA), oriented polypropylene (OPP), and mixtures thereof.

The wood powder paste is composed of the same synthetic resin as that for the main sheet mentioned above, and furthermore, resin having attachability to the main sheet is preferably used.

As conventional material for floors, PVC is mainly used, but has problems related to heat resistance and relatively high electrostatic properties. In consideration of advantages and disadvantages of various general-use plastics, appropriate material should be preferably selected. Moreover, polypropylene (PP) or polyethylene (PE) is particularly useful, because it is superior in printability, heat resistance (melting point of 160˜170° C.), brightness, antistatic property, moisture resistance, light resistance, mechanical strength, light weight, and price competitiveness.

In particular, polypropylene (PP), polyethylene (PE), ethylene-vinyl acetate copolymer (EVA), and oriented polypropylene (OPP) are nonpoisonous and do not contain material which is known to be environmentally harmful hormones. Moreover, upon the preparation of a wood powder layer between the main sheet and a printing layer, a coating layer is formed so as to prevent the flow of an adhesive, a dispersant, a foaming agent, etc., as mentioned below, which are included in a wood powder paste, out of the completed floor, thus realizing a restraining function. Accordingly, end products thus completed are considered to be environmentally friendly, and thus preferable. This is the reason for applying the above synthetic resin to the printing layer.

As such, the wood powder paste is composed of the same synthetic resin as that for the main sheet mentioned above, and furthermore, resin having attachability to the main sheet is preferably used.

In the wood powder layer formation step S20, on the softened main sheet, the wood powder layer is formed to a predetermined thickness using the wood powder paste comprising 30˜80 wt % of the wood powder and 20˜70 wt % of the synthetic resin containing the adhesive. As such, the wood powder is exemplified by natural wood, such as dried wood powder or sawdust, rice hulls, or mixtures of natural wood and rice hulls.

The wood powder, having water content of 5 wt % or less and an average particle size of 20˜500 μm, is thoroughly mixed with the synthetic resin. Based on the total weight of the wood powder paste, the wood powder is used in an amount of 30˜80 wt %.

The process of forming the wood powder layer on the softened main sheet is conducted in such a manner that the wood powder paste is directly applied on the main sheet using an extruder, such as a T-die, and is then passed through a hot rolled roller to thus press the wood powder paste.

However, in order to increase productivity, the present invention can alternatively be realized through a process in which the wood powder paste is molded into a separate wood powder sheet and then the wood powder sheet is laminated or pressed on the main sheet.

To this end, 30˜80 wt % of the wood powder, and 20˜70 wt % of the synthetic resin comprising 15˜50 wt % of the adhesive (e.g., polystyrene type) and 5˜20 wt % of the adjuvant component containing the dispersant, based on the total amount of the wood powder paste, are fed into the mixer via the hopper, heated to the melting point of the synthetic resin or higher, mixed, and melted, thus obtaining the wood powder paste. Subsequently, the wood powder paste is extruded using a device such as a T-die and then molded while passing it through a calender. In the calender, in order to prevent contact of the melt with the air and consequent cooling thereof, a series of heating rollers heated to the melting point of the synthetic resin or higher is disposed, and then a series of cooling rollers is disposed to stably cure the wood powder sheet. Accordingly, the wood powder sheet thus obtained is laminated or pressed on the main sheet obtained at step S10.

As the adjuvant component, the dispersant is used to solve the problem in which the wood powder is not uniformly dispersed and mixed in the paste due to the different physicochemical properties between the main material and the wood powder, and is exemplified by methylmethacrylate-butylacrylate copolymer. The dispersant is used in an amount of 0.1˜10 wt %, based on the total weight of the wood powder paste.

In addition, a foaming agent for decreasing the weight of the floor to thus achieve a lightweight product and impart the floor with predetermined resilience may be used. Depending on the properties of the product, the foaming agent is used in an amount of 0.005˜3 wt %, based on the total weight of the wood powder paste. As such, azodicarbonamide is exemplary.

In addition, in the case of using the foaming agent, a stabilizer for stabilizing the foamed state is preferably used in an amount of 0.1˜7 wt %, based on the total weight of the wood powder paste, examples of which include barium stearate and dibasic lead stearate.

In addition, a softening agent, such as stearic acid, or a lubricant such as oxidized polyethylene homopolymer, may be used to improve the quality of the product.

Thereafter, the exposed surface of the laminate sheet, obtained by attaching the wood powder layer to the main sheet, in particular, the surface of the wood powder layer, is subjected to embossing treatment so as to realize the texture of natural material, such as a wood texture or rock texture, at step S30.

The embossing process may be conducted before or after a patterning step S50.

As in FIG. 1, in the case where the embossing process is conducted after the lamination process of S20, since the laminate sheet is not cured, embossing treatment may be performed using only a roller having a predetermined negative or positive pattern.

During storage and transport of the floor thus produced, or before or after the manufacture thereof, a deformation prevention step S40 is performed through cooling for preventing deformation of the product due to changes in temperature and humidity, to thus realize dimensional stability. This is conducted in such a manner that the laminate sheet is passed through a water bath containing water at 20˜35° C. Through such a cooling process of S40, the embossments may be cured.

Subsequently, the patterning step S50 is performed for forming a printing layer having a predetermined pattern on the molded panel, using transfer printing, direct printing, gravure printing, or combinations thereof.

In the case where the material for the printing layer is different from that for the laminate sheet, the process of heating to the softening temperature of the main sheet or higher is preferably required to realize efficient and complete printing.

If the main sheet is formed of polypropylene (PP), the transfer temperature is set to be about 170° C. or higher, which is the softening temperature of polypropylene, and preferably 180˜200° C.

Polyethylene terephthalate (PET), having heat resistance suitable for such temperature conditions and a low price, is preferably used as the base film of the transfer paper.

In addition to polyethylene terephthalate (PET), the base film of the transfer paper may be formed using sulfonated polystyrene (SPS). More preferably, in order to realize environmentally friendly properties and a non-toxic function, useful is any one selected from among polypropylene (PP), polyethylene (PE), ethylene-vinyl acetate copolymer (EVA), and oriented polypropylene (OPP).

On the base film of the transfer paper, a release primer layer may be formed. The release primer is used so that the pattern can be easily removed from the base film in the course of transferring the pattern to an objective. Thus, it is possible to improve poor peelability, undesirably occurring when the conditions are wet or heat is poorly transferred in the heat transfer process.

The release primer is composed of 4˜5 wt % of acryl polymer, 19˜20 wt % of PVC copolymer, 1˜2 wt % of nitrocellulose (NC), 69˜70 wt % of methylethylketone (MEK), 1˜2 wt % of silica and 1˜2 wt % of a dispersant.

Further, a pattern is printed on the release primer layer using general ink. As such, the general ink typically consists of 6˜17 parts by weight of a pigment, 50˜110 parts by weight of a methylethylketone (MEK) solvent, and 50˜70 parts by weight of a medium (acryl resin, PVC copolymer, and solvent such as toluene or methylethylketone) for fixing the pigment to the objective.

Furthermore, an adhesive primer layer is formed on the ink layer. The adhesive primer is a heat adhesive exhibiting adhesive strength only when heated, and may be in an oil or aqueous form. The oily heat adhesive comprises 1˜20 wt % of polyurethane, 10˜50 wt % of a PVC copolymer, 1˜3 wt % of a dispersant, 1˜2 wt % of a defoaming agent, and 25˜80 wt % of methylethylketone, and the aqueous heat adhesive comprises 18˜50 wt % of acryl resin, 3˜20 wt % of water, 30˜60 wt % of alcohol, and 1˜2 wt % of nitrocellulose.

That is, in the transfer paper used in the present invention, it is preferred that an additional adhesive layer, such as an adhesive primer layer, be formed. This is because, in the case where the main sheet is a PP film, it is difficult to permeate the main sheet with adhesive methylethylketone due to the high density of PP.

The pattern obtained in the patterning step S50 includes, for example, a wood pattern, or a stone pattern, such as marble or natural rock.

Subsequently, through a functional coating layer formation step S60, a coating layer for antibacterial coating, scuff-resistant coating, or both of them may be formed. The antibacterial coating layer may be formed using nano-silver. Additionally, for protection of a product through UV blocking, a UV blocking layer may be applied. A transparent film for scuff resistance or pattern protection may be formed using general-use plastic (e.g., PVC) or high-impact polystyrene (HIPS), which is transparent.

After the coating process of S60, since the laminate sheet is not completely cured, embossing treatment may be further conducted. In this case, such an embossing treatment may be carried out to be the same as or different from the above embossing step S30.

In order to prevent the deformation of floors due to contraction and expansion depending on changes in temperature and humidity, to thus increase dimensional stability, an aging step S70 is conducted after the cooling for deformation prevention step S40. The aging step is preferably conducted in such a manner that the laminate sheet is passed through the water bath containing water at 100˜180° C. for a time period ranging from 30 sec to 10 min.

Thereafter, as a post treatment step S80, cooling to room temperature, drying, and cutting, are formed, consequently packaging a product. The cutting process is used to cut the product to a predetermined size, accompanied by a trimming process.

In practice, the floor is composed of a lower layer, an intermediate layer, and an upper layer, which are sequentially formed in an upward direction. The manufacturing method of the present invention may be applied only to the intermediate layer, positioned between the lower layer and the upper layer of the multilayered floor. In such a case, in order to impart the floor with dimensional stability, a glass fiber layer, in which a glass fiber mat is incorporated, is provided. Using a thermal transfer process, a printing layer is transferred between the glass fiber layer and the upper layer (e.g., PVC). Further, in order to prevent the floor from causing pollution, on the upper layer thereof, a UV coating layer is applied, or polyurethane treatment is performed to thus increase pollution resistance.

As described hereinbefore, the present invention provides a floor including wood powder and a method of manufacturing the same. According to the present invention, synthetic resin, used in an environmentally friendly floor including wood powder, in particular, synthetic resin used in a printing layer, comprises any one selected from among polypropylene (PP), polyethylene (PE), ethylene-vinyl acetate copolymer (EVA), and oriented polypropylene (OPP), thus realizing nonpoisonous, environmentally friendly, and safe products.

According to the floor including wood powder and the manufacturing method thereof, a wood powder layer, in particular, a separately molded wood powder sheet, is integratedly laminated on a main sheet made of synthetic resin using a wood powder paste containing wood powder. Further, the wood powder is mixed with the synthetic resin to thus increase the melting point of the laminate sheet. Thereby, the printing layer, having material different from that of the laminate sheet, can be easily attached, therefore realizing floors that have a texture similar to that of natural wood and are environmentally friendly.

In addition, the floor is passed through a water bath containing water at 100˜180° C. to thus age it, consequently preventing deformation thereof due to contraction and expansion in response to changes in temperature and humidity. Further, an embossing process, for imparting a wood texture, and a coating layer formation process, for forming an antibacterial and scuff-resistant coating, may be further performed, thus improving the quality of the product.

A detailed description of typically known techniques related to the floor and the manufacturing method thereof, that is, master batch, mixing, melting, sheet molding, lamination, embossing, and printing, is omitted, because such will be obvious to those skilled in the art.

Although the preferred embodiment of the present invention, according to the sequence of the process shown in the drawing, has been disclosed for illustrative purposes, those skilled in the art will appreciate that various modifications, additions and substitutions are possible, without departing from the scope and spirit of the invention as disclosed in the accompanying claims.

1. A floor including wood powder, comprising:
a main sheet formed of synthetic resin;
a wood powder layer formed on the main sheet using a mixture of wood powder and synthetic resin; and
a printing layer formed on the wood powder layer and having a non-toxic portion, the printing layer being attached when heated, due to changes in a melting point of the main sheet.

2. The floor as set forth in claim 1, wherein the non-toxic portion of the printing layer is formed of any one material selected from among polypropylene, polyethylene, ethylene-vinyl acetate copolymer, oriented polypropylene, and polyethylene terephthalate.

3. The floor as set forth in claim 1, wherein the wood powder layer comprises 30˜80 wt % of wood powder and 20˜70 wt % of synthetic resin containing an adhesive.

4. A method of manufacturing a floor including wood powder, comprising:
(a) a main sheet softening step of heating and softening a synthetic resin sheet, continuously transferred from a feed roller, using a heating means;
(b) a wood powder layer formation step of forming a wood powder layer having a predetermined thickness on the softened main sheet using a wood powder paste comprising 30˜80 wt % of wood powder and 20˜70 wt % of synthetic resin containing an adhesive, to thus obtain a laminate sheet; and
(c) a patterning step of forming a predetermined pattern on the laminate sheet.

5. The method as set forth in claim 4, wherein the wood powder layer formation step (b) is performed by feeding 30˜80 wt % of the wood powder and 20˜70 wt % of the synthetic resin, comprising 15˜50 wt % of the adhesive and 5˜20 wt % of an adjuvant component containing a dispersant, based on a total weight of the wood powder paste, into a mixer via a hopper, and heating, mixing, and melting them, to thus obtain a wood powder paste, which is then passed through a calender including a heating roller group and a cooling roller group and thus molded into a wood powder sheet having a predetermined thickness, after which the wood powder sheet is laminated or pressed on the main sheet obtained in the step (a).

6. The method as set forth in claim 5, wherein the adjuvant component further comprises a foaming agent, a stabilizer, a lubricant, and a softening agent, in addition to the dispersant.

7. The method as set forth in claim 4, wherein the patterning step (c) is performed using a printing layer formed of any one material selected from among polypropylene, polyethylene, ethylene-vinyl acetate copolymer, oriented polypropylene, and polyethylene terephthalate.

8. The method as set forth in claim 4, wherein the patterning step (c) is performed through a transfer printing process, in which the transfer printing process comprises a process of heating the main sheet so that a temperature for the transfer printing process is set to be not lower than a softening temperature of the main sheet.

9. The method as set forth in claim 4, further comprising (d) an aging step of passing the sheet through a water bath containing water at 100˜180° C., after the patterning step (c); and (e) a post treatment step of performing cooling, drying and cutting.

10. The method as set forth in claim 4, further comprising (b-1) a deformation prevention step of cooling the laminate sheet comprising the main sheet and the wood powder layer to 20˜35° C., after the wood powder layer formation step (b).

11. The method as set forth in claim 5, further comprising (d) an aging step of passing the sheet through a water bath containing water at 100˜180° C., after the patterning step (c); and (e) a post treatment step of performing cooling, drying and cutting.

12. The method as set forth in claim 6, further comprising (d) an aging step of passing the sheet through a water bath containing water at 100˜180° C., after the patterning step (c); and (e) a post treatment step of performing cooling, drying and cutting.

13. The method as set forth in claim 7, further comprising (d) an aging step of passing the sheet through a water bath containing water at 100˜180° C., after the patterning step (c); and (e) a post treatment step of performing cooling, drying and cutting.

14. The method as set forth in claim 8, further comprising (d) an aging step of passing the sheet through a water bath containing water at 100˜180° C., after the patterning step (c); and (e) a post treatment step of performing cooling, drying and cutting.
